(19) United States
(12) Patent Application Publication
(10) Pub. No.: US 2017/0212682 A1
(43) Pub. Date: Jul. 27, 2017

(54) TIME DE-INTERLEAVING CIRCUIT AND METHOD THEREOF

(71) Applicant: MStar Semiconductor, Inc., Hsinchu Hsien (TW)

(72) Inventor: CHUN-CHIEH WANG, Hsinchu County (TW)

(21) Appl. No.: 15/399,120

(22) Filed: Jan. 5, 2017

(30) Foreign Application Priority Data
Jan. 26, 2016 (TW) 105102281

(51) Int. Cl. G06F 3/06

(52) U.S. Cl. CPC G06F 3/064; G06F 3/0619; G06F 3/0659; H04L 1/0071

(57) ABSTRACT

A time de-interleaving method is applied to a signal receiver of a communication system to perform a time de-interleaving process on an interleaved signal. The interleaved signal includes a first time interleaved block and a second time interleaved block. The time de-interleaving method includes: reading a first part of cells of the first time interleaved block from a memory; releasing a memory space corresponding to the first part of the cells in the memory; and writing a second part of cells of the second time interleaved block into the memory space before the first time interleaved block is completely read out from memory.

This application claims the benefit of Taiwan application Serial No. 105102281, filed Jan. 26, 2016, the subject matter of which is incorporated herein by reference.

### BACKGROUND OF THE INVENTION

Field of the Invention

The invention relates in general to a time de-interleaving circuit and method, and more particularly to a row-column or block time de-interleaving circuit and method.

Description of the Related Art

To prevent a large amount of bit errors occurring in a short period of time in a way that data originally transmitted cannot be recovered by means of error correction, data to be transmitted is often randomly distributed in a communication system. Thus, original consecutive errors become random errors, and so most of the errors may then be corrected through error correction to reduce the error rate. The time interleaving process is a common interleaving process in a communication system. In a time interleaving process, a data block is sequentially written into a memory one row after another at a transmitter and sequentially read out from the memory one column after another, such that the data of the data block is redistributed to form a time interleaved block. The time interleaving process is performed in a unit of blocks, and is also referred to as a block interleaving process. A receiver of the communication system then performs a corresponding time de-interleaving process.

A time interleaved (TI) block includes N_{FEC} forward error correction (FEC) blocks, each of which including N_{cell} cells, where N_{FEC} and N_{cell} are defined by associated communication standards. A conventional time de-interleaving circuit usually needs to reserve two memory blocks—one for writing data into and the other for reading data from in a certain operation phase, and the roles of the two are swapped in a next phase. FIG. 1a and FIG. 1b show schematic diagrams of memory configurations conventionally used for time de-interleaving. In each of FIG. 1a and FIG. 1b, two memory blocks 110 and 120 are included, and the memory configuration of each of the memory blocks is Nc (=N_{cell}/5, and N_{cell}=20 in this example, and so Nc=4) columns and Nr (=N_{FEC}×5, and N_{FEC}=2 in this example, and so Nr=10) rows; that is, each memory block may store a data amount of one TI block (in this example, one TI block includes N_{FEC}×N_{cell}=2×20=40 cells). In the state of FIG. 1a, all of the cells (a0 to a39) of one TI block are exactly written into the memory block 110, and all of the cells originally stored in the memory block 120 are exactly completely read. In the next phase, data is read from the memory block 110, and new data is written into the memory block 120. FIG. 1b shows a schematic diagram of the configuration of the memory block 110 and the memory block 120 each having been read 20 times and written 20 times. It is discovered from FIG. 1a and FIG. 1b that, at any given moment, a memory space equal to the data amount of one TI block (equivalent to the size of one memory block 110 or 120) is empty. One reason causing the above is that, both of the memory block 110 and the memory block 120 are designed to use a unit of the data amount of one TI block. Thus, the utilization efficiency of the memory is reduced.

### SUMMARY OF THE INVENTION

The invention is directed to a time de-interleaving circuit and method to save memory.

The present invention discloses a time de-interleaving method applied to a signal receiver of a communication system to perform a time de-interleaving process on an interleaved signal. The interleaved signal includes a first time interleaved block and a second time interleaved block. The time de-interleaving method includes: reading a first part of cells of the first time interleaved block from a memory; releasing a memory space in the memory corresponding to the first part of the cells; and writing a second part of cells of the second time interleaved block into the memory space before the first time interleaved block is completely read from the memory.

The present invention further discloses a time de-interleaving circuit applied to a signal receiver of a communication system to perform a time de-interleaving process on an interleaved signal. The signal receiver includes a memory. The interleaved signal includes a first time interleaved block and a second time interleaved block. The time de-interleaving circuit includes: a reading address generator, generating a reading address; a writing address generator, generating a writing address; and a memory control circuit, reading a first part of cells of the first time interleaved block from a memory space according to the reading address, and writing a second part of cells of the second time interleaved block into the memory space according to the writing address before the first time interleaved block is completely read out.

The time de-interleaving circuit and method of the present invention uses a memory sub-block smaller than a data amount of one TI block as an access unit, so that the memory can be more flexibly utilized to reduce memory requirements of time de-interleaving.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1a and FIG. 1b are schematic diagrams of memory configurations conventionally used for time de-interleaving;

FIG. 2 is a block diagram of a time de-interleaving circuit according to an embodiment of the present invention;

FIG. 3 is a flowchart of a time de-interleaving method according to an embodiment of the present invention; and

FIG. 4a to FIG. 4m are schematic diagrams of memory configurations used for time de-interleaving of the present invention.

### DETAILED DESCRIPTION OF THE INVENTION

The disclosure includes a time de-interleaving circuit and method. In possible implementation, one person skilled in the art may choose equivalent elements or steps based on the disclosure of the application to realize the present invention. That is, the implementation of the present invention is not limited to the non-limiting embodiments below.

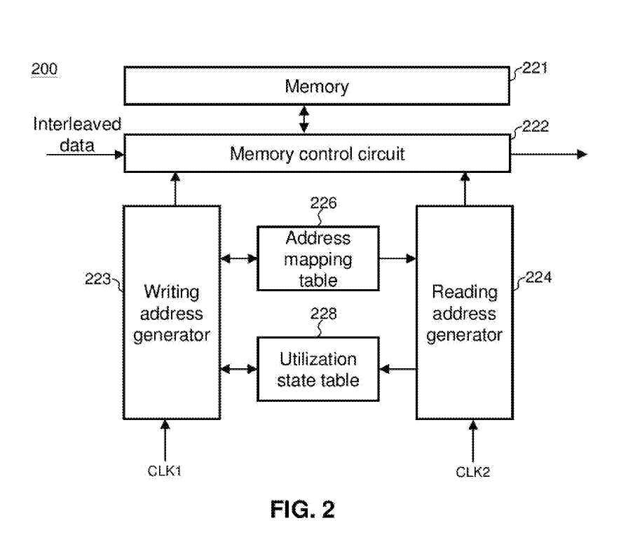

FIG. 2 shows a block diagram of a time de-interleaving circuit according to an embodiment of the present invention. Referring to FIG. 2, a time de-interleaving circuit 200 includes a memory 221, a memory control circuit 222, a writing address generator 223, a reading address generator 224, an address mapping table 226 and a utilization state table 228. The writing address 223 and the reading address generator 224 respectively generate a writing address and a reading address according to the address mapping table 226 and/or the utilization state table 228. The memory control circuit 222 writes and reads a time interleaved (TI) block in interleaved data into and from the memory 221 according to the writing address and the reading address to perform time de-interleaving. In another embodiment of the present invention, the time de-interleaving circuit may perform time de-interleaving using an externally connected memory.

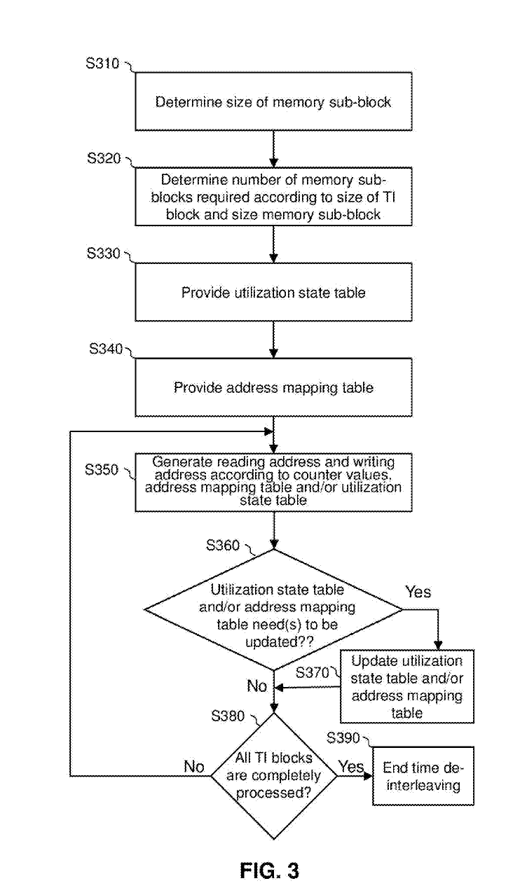

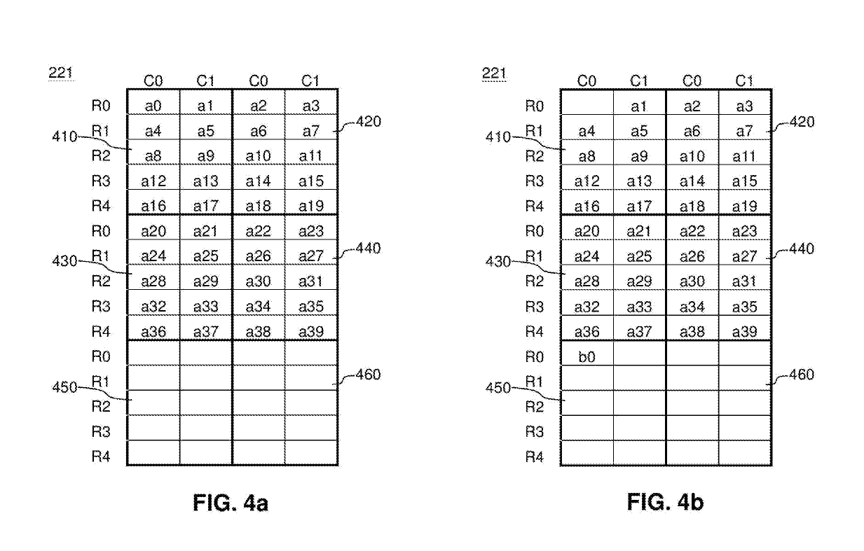

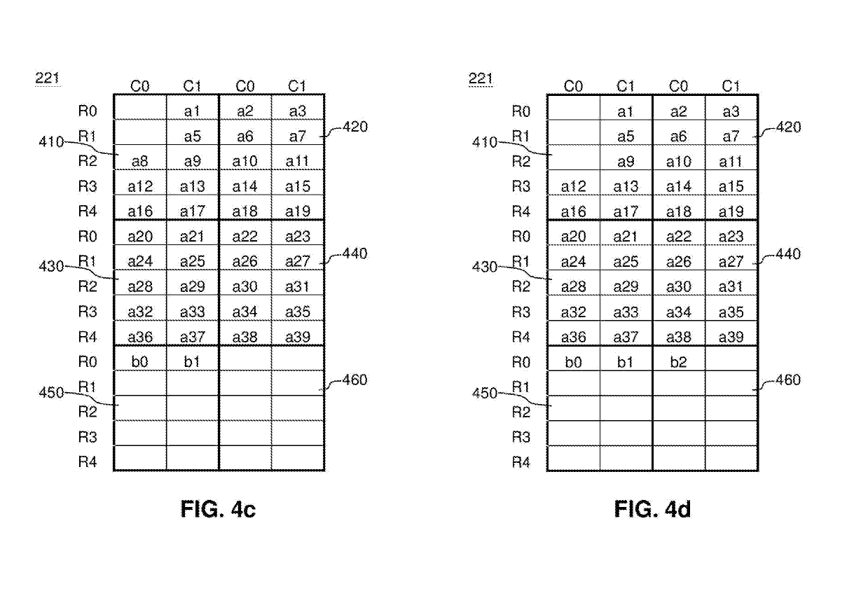

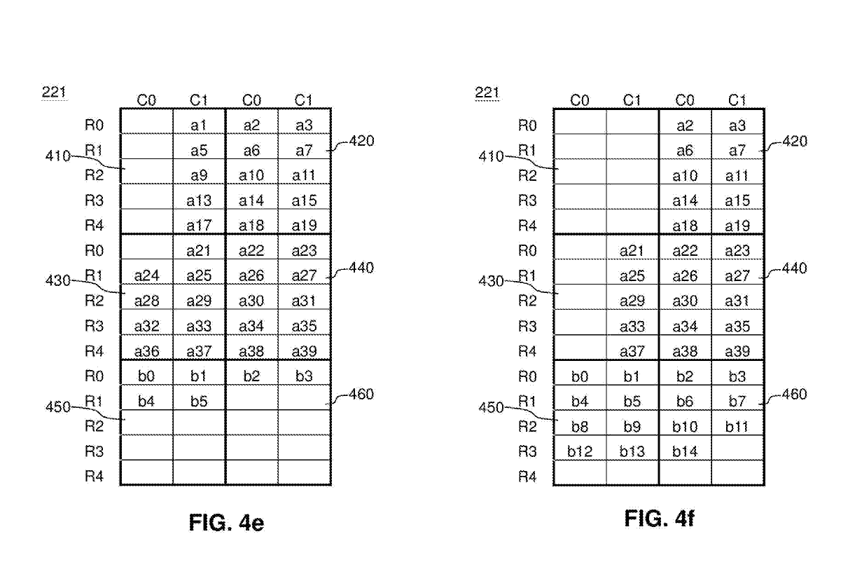

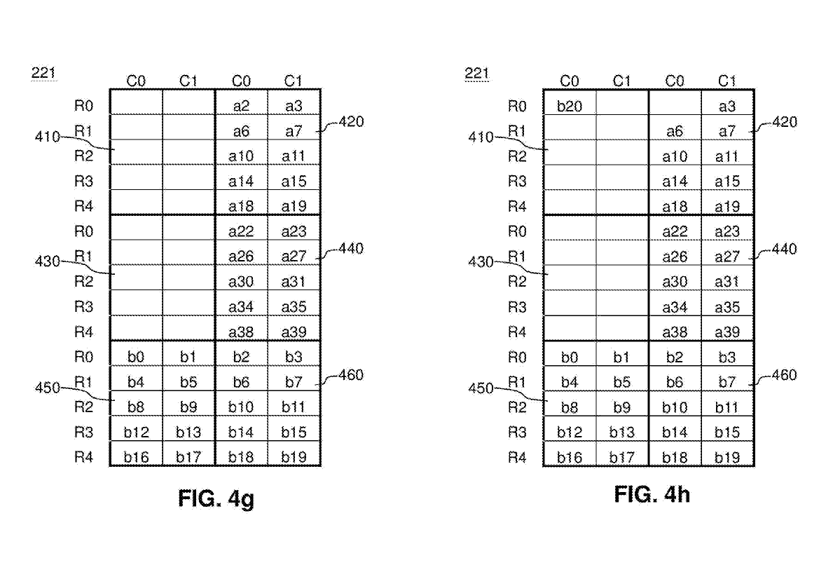

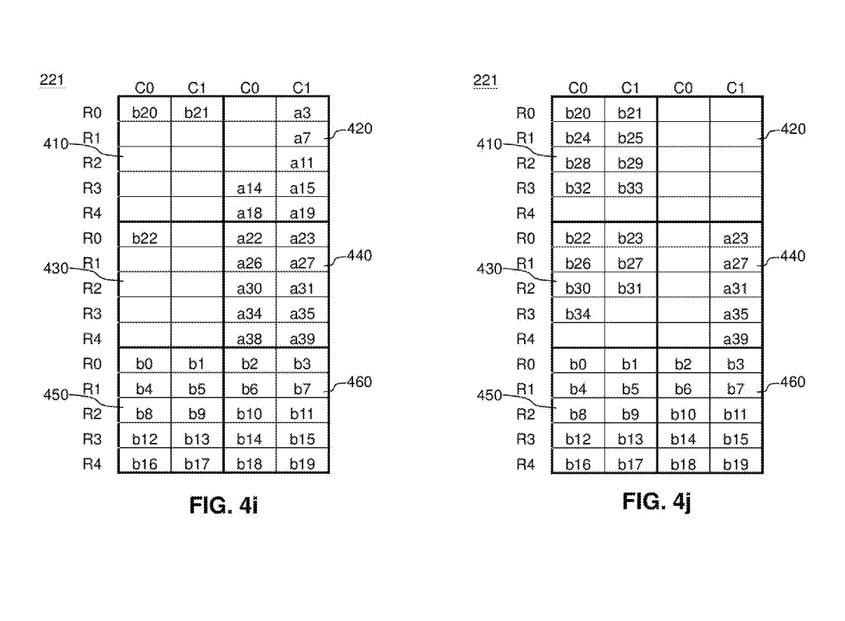

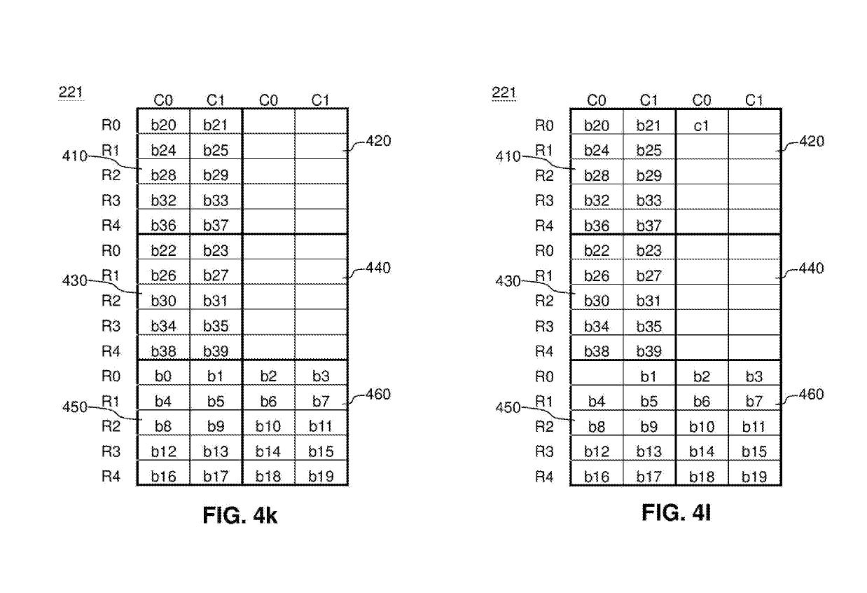

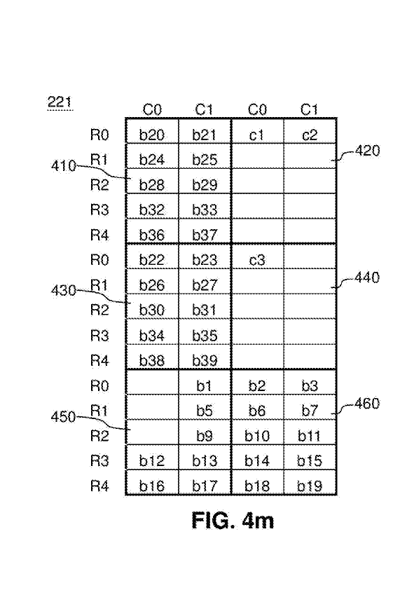

FIG. 3 shows a flowchart of a time de-interleaving method according to an embodiment of the present invention. Referring to schematic diagrams of memory configurations in FIG. 4a to FIG. 4m, operation principles of the time de-interleaving circuit 200 are given in detail below. In step S310, the size of a memory sub-block is determined. In this embodiment, taking a sub-block having a row count r=5 and a column count c=2 for example, each sub-block may store 2 columns×5 rows=10 cells. In step S320, according to the size of the TI block and the size of the memory sub-block, the number of memory sub-blocks required is determined. The number k of sub-blocks may be determined according to an equation:

$$k = ( \frac{{SN}_{FEC}}{r} + 1 ) \times \frac{{N}_{cell}}{5 c} \qquad ( 1 )$$

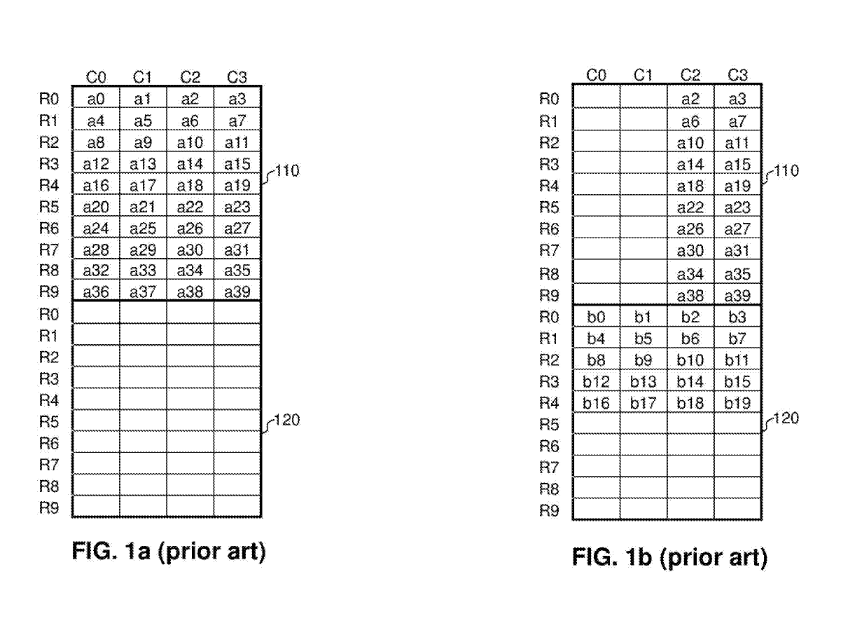

In continuation of the example in FIG. 1 (i.e., N_{cell}=20 and N_{FEC}=2), the number of sub-blocks that the present invention requires is k=(5×2/5+1)×(20/5/2)=3×2=6. As shown in FIG. 4a, the memory 221 includes 6 same-sized memory blocks 410 to 460. In fact, equation (1) may be re-written as:

$$k = ( \frac{{N}_{r}}{r} + 1 ) \times \frac{{N}_{c}}{c} = \frac{{N}_{r}}{r} \times \frac{{N}_{c}}{c} + \frac{{N}_{c}}{c} \qquad ( 2 )$$

In equation (2), (Nr/r)×(Nc/c) is the number of equivalent sub-blocks of the memory block 110 or the memory block 120, and so a conventional de-interleaving process requires a total of 2×(Nr/r)×(Nc/c)=2×(10/5)×(4/2)=8 sub-blocks, which is (Nr/r−1)×(Nc/c) more sub-blocks compared to the present invention. It is seen that, for the same-sized TI blocks (i.e., having same Nc and same Nr), as the number of sub-blocks adopted in the present invention increases (that is, as the size of each sub-block gets smaller, i.e., as the value or r or c gets smaller), the larger the memory the present invention saves.

In step S330, a utilization state table 228 is provided. The utilization table 228 indicates the utilization state of each of the memory sub-blocks. In one embodiment, the utilization state table 228 includes k bits, each of which corresponding to one sub-block, and logic values 1 and 0 represent whether the sub-block is empty or in use. In step S340, an address mapping table 226 is provided. The address mapping table 226 records a corresponding relationship between a logical address of a logical sub-block and a physical address of a physical sub-block when the memory 221 is accessed, and provides a reference for the writing address generator 223 and the reading address generator 224 to accordingly generate the writing address and the reading address. It is assumed that the writing address generator 223 and the reading address generator 224 can access a total of 2×(Nr/r)×(Nc/c) logic sub-blocks (or referred to as virtual sub-blocks) during an operation, and the physical sub-blocks are then mapped using the address mapping table 226. In continuation of the above example, thus, the number of fields of the address mapping table 226 is equal to 2×(Nr/r)×(Nc/c)=8. Further, each of the fields needs to have an enough bit count for indicating the corresponding physical sub-blocks, and the required bit count is [log₂ k]=[log₂ 6]=3. In practice, the utilization state table 228 and the address mapping table 226 are stored in a memory, e.g., a static random access memory (SRAM).

An operation process of the present invention is given in detail below with reference to a change order of the address mapping table 226 and the utilization state table 228 in Table-1. FIG. 4a shows that the time de-interleaving circuit 200 is writing one complete TI block A (cells a0 to a39) to the memory 221 and has just finished reading from another TI block that is previously written. At this point, from the 0^{th}-round reading/writing operation corresponding to Table-1, the utilization state table 228 is obtained as {0, 0, 0, 0, 1, 1} (representing the sub-blocks 410 to 460 from the left to right, respectively, meaning that the sub-blocks 410 to 440 are in use whereas the sub-blocks 450 and 460 are empty in this example) and the address mapping table 226 is {0, 1, 2, 3, x, x, x, x} (the values in the fields are represented in decimal, with 0 representing the sub-block 410, 1 representing the sub-block 420, and so forth). It should be noted that, the utilization state table 228 and the address mapping table 226 in Table-1 as well as the corresponding drawings are results after this reading/writing operation (the parts underlined are modified in this operation), and the reading/writing operation rounds listed in Table-1 are simplified expressions; that is, an operation round of reading one complete TI block A and writing one complete TI block B (cells b0 to b39) is given as an example. One person skilled in the art can apply the operation to more TI blocks based on the illustration and teaching below. Further, the writing address generator 223 and the reading address generator 224 in fact include respective counters that respectively count according to clock signals CLK1 and CLK2 (respectively associated with the speeds at which the cells are written into and read from the memory 221). The writing address generator 223 and the reading address generator 224 further include respective determining units, which respectively generate the writing address and the reading address according to the counter values, the address mapping table 226 and/or the utilization state table 228 in step S350, and further determine whether to update the utilization state table 228 and/or the address mapping table 226 in step S360. More specifically, in step S360, the determining unit of the writing address generator 223 learns whether an empty sub-block is currently to be written according to the size of the TI block (i.e., N_{cell} and N_{FEC}), the size of the sub-block (values of r and c) and the counter value. If so, in step S370, an empty sub-block is looked up from the utilization state table 228, and the utilization state table 228 and the address mapping table 226 are correspondingly updated after the empty sub-block is found. On the other hand, the determining unit of the reading address generator 224 learns whether the last cell of one sub-block is currently being read according to the size of the TI block, the size of the sub-block and the counter value. If so, in step S370, the utilization state table 228 is updated. In a different embodiment, the updating of the utilization state table 228 and/or the address mapping table 226 may be performed by the memory control circuit 222 according to the output(s) of the writing address generator 223 and/or the reading address generator 224. In practice, the relationship between the reading/writing operation round in Table-1 and the counter value (CNT) is: round=CNT mod (N_{cell}×N_{FEC}). Therefore, although “round” is used in the illustration below, it is to be understood that the term “round” in fact represents the counter value.

TABLE 1

| | Utilization | Address | | | Utilization | Address | Corre- |
|---|---|---|---|---|---|---|---|
| | state table | mapping table | Corresponding | | state table | mapping table | sponding |
| operation | 228 | 226 | FIG. | operation | 228 | 226 | FIG. |
| 0 | {0, 0, 0, 0, 1, 1} | {0, 1, 2, 3, x, x, x, x} | FIG. 4a | | | | |
| 1 | {0, 0, 0, 0, 0, 1} | {0, 1, 2, 3, 4, x, x, x} | FIG. 4b | 21 | {0, 0, 1, 0, 0, 0} | {0, 1, 2, 3, 4, 5, 0, x} | FIG. 4 h |
| 2 | {0, 0, 0, 0, 0, 1} | {0, 1, 2, 3, 4, x, x, x} | FIG. 4c | 22 | {0, 0, 1, 0, 0, 0} | {0, 1, 2, 3, 4, 5, 0, x} | — |
| 3 | {0, 0, 0, 0, 0, 0} | {0, 1, 2, 3, 4, 5, x, x} | FIG. 4d | 23 | {0, 0, 0, 0, 0, 0} | {0, 1, 2, 3, 4, 5, 0, 2} | FIG. 4i |
| 4 | {0, 0, 0, 0, 0, 0} | {0, 1, 2, 3, 4, 5, x, x} | — | 24 | {0, 0, 0, 0, 0, 0} | {0, 1, 2, 3, 4, 5, 0, 2} | — |
| 5 | Same as | Same as above | — | 25 | Same as | Same as above | — |
| | above | | | | above | | |
| 6 | Same as | Same as above | FIG. 4e | 26 | Same as | Same as above | — |
| | above | | | | above | | |
| 7 | Same as | Same as above | — | 27 | Same as | Same as above | — |
| | above | | | | above | | |
| 8 | Same as | Same as above | — | 28 | Same as | Same as above | — |
| | above | | | | above | | |
| 9 | Same as | Same as above | — | 29 | Same as | Same as above | — |
| | above | | | | above | | |
| 10 | Same as | Same as above | — | 30 | Same as | Same as above | — |
| | above | | | | above | | |
| 11 | Same as | Same as above | — | 31 | Same as | Same as above | — |
| | above | | | | above | | |
| 12 | Same as | Same as above | — | 32 | Same as | Same as above | — |
| | above | | | | above | | |
| 13 | Same as | Same as above | — | 33 | Same as | Same as above | — |
| | above | | | | above | | |
| 14 | Same as | Same as above | — | 34 | Same as | Same as above | — |
| | above | | | | above | | |
| 15 | {1, 0, 0, 0, 0, 0} | Same as above | FIG. 4f | 35 | {0, 1, 0, 0, 0, 0} | Same as above | FIG. 4j |
| 16 | {1, 0, 0, 0, 0, 0} | Same as above | — | 36 | {0, 1, 0, 0, 0, 0} | Same as above | — |
| 17 | Same as | Same as above | — | 37 | Same as | Same as above | — |
| | above | | | | above | | |
| 18 | Same as | Same as above | — | 38 | Same as | Same as above | — |
| | above | | | | above | | |
| 19 | Same as | Same as above | — | 39 | Same as | Same as above | — |
| | above | | | | above | | |
| 20 | {1, 0, 1, 0, 0, 0} | {0, 1, 2, 3, 4, 5, x, x} | FIG. 4g | 40 | {0, 1, 0, 1, 0, 0} | {0, 1, 2, 3, 4, 5, 0, 2} | FIG. 4k |

Examples are given below to describe operation details and the configurations of the memory 221 (FIG. 4a to FIG. 4m) when there are changes in the address mapping table 226 and/or the utilization state table 228.

When round=1, the writing address generator 223 learns that a new sub-block is to be written into according to the size of the TI block, the size of the sub-block and the counter value, and further learns that the sub-block 450 is empty according to the utilization state table 228. Thus, in step S350, the writing address generator 223 generates the writing address corresponding to the address (R0, C0) of the sub-block 450, and the reading address generator 224 generates the reading address corresponding to the address (R0, C0) of the sub-block 410. In step S360, the determination result is affirmative. In step S370, the writing address generator 223 changes the logic value corresponding to the sub-block 450 in the utilization state table 228 from 1 to 0, and fills the value of the address corresponding to the 5^{th} logical sub-block (corresponding to the sub-block 450) in the address mapping table 226 to 4.

When round=2, in step S350, according to the size of the TI block, the size of the sub-block and the counter value, the reading address generator 224 and the writing address generator 223 respectively generate the reading address corresponding to the address (R1, C0) of the sub-block 410 and the writing address corresponding to the address (R0, C1) of the sub-block 450. In step S360, the determination result is negative.

When round=3, according to the size of the TI block, the size of the sub-block and the counter value, the writing address generator 223 learns that a new sub-block is to be written into, and further learns that the sub-block 460 is empty from the utilization state table 228. Thus, in step S350, the writing address generator 223 generates the writing address corresponding to the address (R0, C0) of the sub-block 460, and the reading address generator 224 generates the reading address corresponding to the address (R2, C0) of the sub-block 410. In step S360, the determination result is affirmative. In step S370, the writing address generator 223 changes the logic value corresponding to the sub-block 460 in the utilization state table 228 from 1 to 0, and fills the value of the address corresponding to the 6^{th} logical sub-block (corresponding to the sub-block 460) in the address mapping table 226 to 5.

. . .

When round=6, according to the size of the TI block, the size of the sub-block and the counter value, the reading address generator 224 determines that the logical sub-block 2 is to be read next. According to the address mapping table 226, the logical sub-block 2 maps to the physical sub-block 2 (i.e., the sub-block 430), and so, in step S350, the reading address generator 224 generates the reading address corresponding to the address (R0, C0) of the sub-block 430, and the writing address generator 223 generates the writing address corresponding to the address (R1, C1) of the sub-block 450. In step S360, the determination result is negative.

. . .

When round=15, according to the size of the TI block, the size of the sub-block and the counter value, the reading address generator 224 learns that the last cell a17 (i.e., the address (R4, C1)) of the sub-block 410 is to be read in this operation. On the other hand, in step S350, the writing address generator 223 generates the writing address corresponding to the address (R3, C0) of the sub-block 460. In step S360, the determination result is affirmative. In step S370, the reading address generator 224 changes the flag in the utilization table corresponding to the sub-block 410 to 1, i.e., the memory control circuit 222 releases the sub-block 410.

. . .

When round=20, similar to when round=15, the reading address generator 224 learns that the last cell a37 (i.e., the address (R4, C1)) of the sub-block 430 is to be read in this operation. On the other hand, in step S350, the writing address generator 223 generates the writing address corresponding to the address (R4, C1) of the sub-block 460. In step S360, the determination result is affirmative. In step S370, the reading address generator 224 changes the flag in the utilization state table 228 corresponding to the sub-block 430 to 1, i.e., the memory control circuit 222 releases the sub-block 430.

When round=21, similar to when round=1, in step S350, the reading address generator 224 generates the reading address corresponding to the address (R0, C0) of the sub-block 420, and the writing address generator 223 generates the writing address corresponding to the address (R0, C0) of the sub-block 410. The determination result of step S360 is affirmative. In step S370, the writing address generator 223 changes the logic value corresponding to the sub-block 410 in the utilization state table 228 from 1 to 0, and maps the logical sub-block 7 to the physical sub-block 0 (i.e., the sub-block 410) in the address mapping table 226.

. . .

When round=23, similar to when round=3, in step S350, the reading address generator 224 generates the reading address corresponding to the address (R2, C0) of the sub-block 420, and the writing address generator 223 generates the writing address corresponding to the address (R0, C0) of the sub-block 430. In step S360, the determination result is affirmative. In step S370, the writing address generator 223 changes the logic value corresponding to the sub-block 430 in the utilization state table 228 from 1 to 0, and maps to the logical sub-block 8 to the physical sub-block 2 (i.e., the sub-block 430) in the address mapping table 226.

. . .

When round=35, similar to when round=15, the reading address generator 224 learns that the last cell a19 (i.e., the address (R4, C1)) of the sub-block 420 is to be read in this operation. On the other hand, in step S350, the writing address generator 223 generates the writing address corresponding to the address (R3, C0) of the sub-block 430. In step S360, the determination result is affirmative, so in step S370, the flag corresponding to the sub-block 420 in the utilization state table 228 is change to 1.

. . .

When round=40, similar to when round=35, the reading address generator 224 learns that the last cell a39 (i.e., the address (R4, C1)) of the sub-block 440 is to be read in this operation. On the other hand, in step S350, the writing address generator 223 generates the writing address corresponding to the address (R4, C1) of the sub-block 430. In step S360, the determination result is affirmative, so in step S370, the flag corresponding to the sub-block 440 in the utilization state table 228 is change to 1.

At this point, the reading process of the TI block A and the writing process of the TI block B are complete, and other TI blocks are read/written by repeating the above process. Process details of reading from the TI block B and the writing into the TI block C may be deduced from Table-2 as well as FIG. 4l and FIG. 4m, and such shall be omitted herein. When all of the TI blocks are completely processed, the time de-interleaving process of the present invention ends (steps S380 and S390). The TI block C is temporally subsequently adjacent to the TI block B, and the TI block B is temporally subsequently adjacent to the TI block A.

TABLE 2

| | Utilization | Address | Corresponding |
|---|---|---|---|
| Operation | state table 228 | mapping table 226 | FIG. |
| 0 | {0, 1, 0, 1, 0, 0} | {0, 1, 2, 3, 4, 5, 0, 2} | FIG. 4k |
| 1 | {0, 0, 0, 1, 0, 0} | {1, 1, 2, 3, 4, 5, 0, 2} | FIG. 4l |
| 2 | Same as above | Same as above | — |
| 3 | {0, 0, 0, 0, 0, 0} | {1, 3, 2, 3, 4, 5, 0, 2} | FIG. 4m |

. . .

The above memory sub-blocks may be designed as a same-row memory access unit (or referred to as a tile) to further reduce the number of times of accessing the memory 221. The present invention is suitable for, for example but not limited to, Digital Video Broadcasting-Terrestrial Generation 2 (DVB-T2) and Digital Video Broadcasting-Cable Generation 2 (DVB-C2) transmission standards. According to the specifications of these standards, one TI block may include at most 2¹⁹+2¹⁵ cells, and so N_{FEC}_{_}_{TI}_{_}_{MAX}=(2¹⁹+2¹⁵)/N_{cell} in the table below may be calculated, with the column count and the maximum row count calculated respectively according to N_{cell} and N_{FEC}_{_}_{TI}_{_}_{MAX}.

TABLE 3

| LPDC block | | Cell count of each | Maximum number | Column | |
|---|---|---|---|---|---|
| length | Modulation | LDPC block | of FEC blocks | count | Maximum row |
| (N_{ldpc}) | scheme | (N_{CELL}) | (N_{FEC TI MAX}) | (N_{c}) | count (N_{r,MAX}) |
| 64800 | 256-QAM | 8,100 | 68 | 1,620 | 340 |
| | 64-QAM | 10,800 | 51 | 2,160 | 255 |
| | 16-QAM | 16,200 | 34 | 3,240 | 170 |
| | QPSK | 32,400 | 17 | 6,480 | 85 |
| 16200 | 256-QAM | 2,025 | 275 | 405 | 1,375 |
| | 64-QAM | 2,700 | 206 | 540 | 1,030 |
| | 16-QAM | 4,050 | 137 | 810 | 685 |
| | QPSK | 8,100 | 68 | 1,620 | 340 |

Table-4 shows comparison of sizes of memories required by the present invention and a conventional method. Assume that the size of one cell is 32 bits. In the present invention, the size of one memory sub-cell is designed as c=r=16, i.e., 256 cells can be stored, and so the size of one memory sub-cell is 256×32=8192 bits=1 KB. Taking N_{ldpc}=64800 and Nc=6480 for example, the memory size required by a conventional method is 4,860 KB, and the memory size required by the present invention is 2,835 KB. Adding the sizes required by the address mapping table 226 and the utilization state table 228 ((2,835+58,320)/8/1024=7.5 KB), the present invention requires a total memory size of 2,842.5 KB, which is only about 58.5% of that of the conventional method. It is apparent that the present invention effectively reduces the memory requirement.

TABLE 4

| | | | Memory size | Memory size | | |
|---|---|---|---|---|---|---|
| LPDC | | | required by | required by | | Size of |
| block | Column | Maximum | conventional | present | Size of | address |
| length | count | row count | method | invention | utilization state | mapping table |
| (N_{ldpc}) | (N_{c}) | (N_{r,MAX}) | (KB) | (KB) | table (bits) | (bits) |
| 64800 | 1,620 | 340 | 4,488 | 2,346 | 2,346 | 53,856 |
| | 2,160 | 255 | 4,320 | 2,295 | 2,295 | 51,840 |
| | 3,240 | 170 | 4,466 | 2,436 | 2,436 | 53,592 |
| | 6,480 | 85 | 4,860 | 2,835 | 2,835 | 58,320 |
| 16200 | 405 | 1,375 | 4,472 | 2,262 | 2,262 | 53,664 |
| | 540 | 1,030 | 4,420 | 2,244 | 2,244 | 53,040 |
| | 810 | 685 | 4,386 | 2,244 | 2,244 | 52,632 |
| | 1,620 | 340 | 4,488 | 2,346 | 2,346 | 53,856 |

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A time de-interleaving method, applied to a signal receiver of a communication system to perform a time de-interleaving process on an interleaved signal, the interleaved signal comprising a first time interleaved block and a second time interleaved block, the time de-interleaving method comprising:
reading a first part of cells of the first time interleaved block from a memory;
releasing a memory space in the memory corresponding to the first part of the cells; and
writing a second part of cells of the second time interleaved block into the memory space before the first time interleaved block is completely read out from the memory.

2. The method according to claim 1, wherein the second time interleaved block is temporally adjacent to the first time interleaved block.

3. The method according to claim 2, wherein a size of the memory used for the time de-interleaving process is smaller than a total of data amounts of the first time interleaved block and the second time interleaved block.

4. The method according to claim 1, further comprising:
determining a size of a memory sub-block; and
determining the number of the memory sub-blocks required for performing the time de-interleaving process according to a size of the first time interleaved block and the size of the memory sub-block.

5. The method according to claim 4, wherein a size of the memory space is equal to the size of the memory sub-block.

6. The method according to claim 4, wherein the size of the memory sub-block is equal to a same-row memory access unit of the memory.

7. The method according to claim 4, further comprising:
establishing a utilization state table that indicates utilization states of the memory sub-blocks;
wherein, the step of releasing the memory space in the memory corresponding to the first part of the cells is performed by changing the utilization state table.

8. The method according to claim 7, further comprising:
establishing an address mapping table that indicates a corresponding relationship between sub-blocks of the first time interleaved block and the second time interleaved block and the memory sub-blocks of the memory; and
correspondingly changing the address mapping table in response to the step of writing the second part of the cells of the second time interleaved block into the memory space.

9. A time de-interleaving circuit, applied to a signal receiver of a communication system to perform a time de-interleaving process on an interleaved signal, the interleaved signal comprising a first time interleaved block and a second time interleaved block, the time de-interleaving method comprising:
a reading address generator, generating a reading address;
a writing address generator, generating a writing address; and
a memory control circuit, reading a first part of cells of the first time interleaved block from a memory space of the memory according to the reading address, and writing a second part of cells of the second time interleaved block into the memory space according to the writing address before the first time interleaved block is completely read out.

10. The time de-interleaving circuit according to claim 9, wherein the second time interleaved block is temporally adjacent to the first time interleaved block.

11. The time de-interleaving circuit according to claim 10, wherein a size of the memory used for the time de-interleaving process is smaller than a total of data amounts of the first time interleaved block and the second time interleaved block.

12. The time de-interleaving circuit according to claim 9, wherein the memory comprises a plurality of memory sub-blocks used for the time de-interleaving process, and the number of the memory sub-blocks is associated with a size of the first or second time interleaved block and a size of the memory sub-blocks.

13. The time de-interleaving circuit according to claim 12, wherein a size of the memory space is equal to the size of the memory sub-block.

14. The time de-interleaving circuit according to claim 12, wherein the size of the memory sub-block is equal to a same-row memory access unit of the memory.

15. The time de-interleaving circuit according to claim 12, wherein the reading address generator comprises a first counter that counts according to a first clock, the writing address generator comprises a second counter that counts according to a second clock, the first clock is associated with a speed at which the memory reads the first time interleaved block from the memory, and the second clock is associated with a speed at which the second time interleaved block is written into the memory, the time de-interleaving circuit further comprising:
a storage, storing a utilization state table that indicates utilization states of the memory sub-blocks;
wherein, the reading address generator and the writing address generating are coupled to the storage, the reading address generator generates the reading address according to a counter value of the first counter, the writing address generator generates the writing address according to a counter value of the second counter and the utilization state table, and the reading address generator and the writing address generator determine whether to update the utilization state table respectively according to the counter value of the first counter and the counter value of the second counter.

16. The time de-interleaving circuit according to claim 15, wherein the storage further stores an address mapping table that indicates a corresponding relationship between sub-blocks of the first time interleaved block and the second time interleaved block and the memory sub-blocks, the reading address generator generates the reading address further according to the address mapping table, and the writing address generator updates the address mapping table with reference to the utilization state table.
